(19) United States
(12) Patent Application Publication
(10) Pub. No.: US 2024/0360346 A1
(43) Pub. Date: Oct. 31, 2024

(54) PRESSURE-SENSITIVE ADHESIVE FOR BONDING PRINTING PLATES

(71) Applicant: tesa SE, Norderstedt (DE)

(72) Inventors: Waldemar Schmidt, Hamburg (DE); Eugen Fomenko, Norderstedt (DE); Ralf Kretzmer, Hamburg (DE); Kai Ellringmann, Hamburg (DE); Bianca Mayer, Hamburg (DE)

(73) Assignee: tesa SE, Norderstedt (DE)

(21) Appl. No.: 18/646,409

(22) Filed: Apr. 25, 2024

(30) Foreign Application Priority Data
Apr. 27, 2023 (DE) 102023110975.8

(51) Int. Cl. C09J 7/38; C09J 133/08

(52) U.S. Cl. CPC C09J 7/385; C09J 133/08; C09J 2301/50

(57) ABSTRACT

A pressure-sensitive adhesive for bonding printing plates, comprising one or more copolymers in a combined mass fraction of 30% or more, based on the mass of the pressure-sensitive adhesive, where the one or more copolymers are preparable by polymerizing a monomer composition and optionally subsequently crosslinking the polymers, where the monomer composition, based on the mass of the monomer composition, comprises: i) one or more specific first monomers in a combined mass fraction in the range from 5% to 15%, ii) one or more specific second monomers in a combined mass fraction of 70% or more, and iii) one or more specific third monomers in a combined mass fraction in the range from 5% to 15%.

### CROSS-REFERENCE TO RELATED APPLICATION

This application claims the benefit of priority under 35 U.S.C. § 119 of German Patent Application No. DE102023110975.8, entitled “PRESSURE-SENSITIVE ADHESIVE FOR BONDING PRINTING PLATES”, and filed Apr. 27, 2023, the contents of which is relied upon and incorporated herein by reference in its entirety.

### FIELD OF THE DISCLOSURE

The disclosure relates to a pressure-sensitive adhesive (PSA) for the bonding of printing plates, to a corresponding pressure-sensitive adhesive tape, and to the use of corresponding pressure-sensitive adhesives and pressure-sensitive adhesive tapes for improving the detachability of the printing plates in the processing of ink.

### BACKGROUND

The joining of separate elements is one of the central processes in manufacturing. As well as other methods, such as welding and soldering, for example, an important significance is nowadays accorded in particular to adhesive bonding, i.e., to joining using an adhesive. One alternative to the use of formless adhesives which are applied from a tube, for example, are so-called adhesive tapes, whose bonding effect derives from the adhesives employed.

For numerous technical applications, pressure-sensitive adhesive tapes in particular are relevant, where a PSA provides the bonding effect, being durably tacky and also adhesive under customary ambient conditions. Such pressure-sensitive adhesive tapes can be applied to a substrate by pressure and remain adhering there, but later on can be removed again more or less without residue.

There are numerous technical fields in which pressure-sensitive adhesive tapes enjoy great popularity, since generally they are particularly easy to use and enable the rapid and uncomplicated joining of multiple elements. As well as fields of use in industries whose products are part of everyday life for the majority of people, as in the manufacture of vehicles and electronic devices, for example, pressure-sensitive adhesive tapes are also employed in areas which are less apparent on an everyday basis. Here it is frequently these very applications-usually highly specialized-that impose particular requirements on the physicochemical properties of PSAs.

One important branch of industry which is particularly reliant on performance-capable pressure-sensitive adhesive tapes is the printing industry. In the printing industry there are various known processes for transferring designs to substrates, with that known as flexographic printing having particularly great significance. In the flexographic printing process, flexible printing plates are affixed to printing cylinders or printing sleeves. These flexible plates frequently consist of a polyethylene terephthalate (PET) film bearing an applied layer of a photopolymer in which the corresponding print relief can be established by selective exposure to light. In the flexographic printing process, pressure-sensitive adhesive tapes, usually in the form of double-sided adhesive tapes, are used in particular for securing the printing plates, used for printing substrates, on the printing cylinders or printing sleeves of the apparatuses used.

The requirements of the printing industry are that during the printing operation it is possible to ensure sufficient assembly strength of the adhered printing plates, even at elevated temperatures of about 40 to 60° C. At the same time, however, after printing, the corresponding printing plates must be able to be removed extremely easily and time-efficiently from the apparatuses, possibly even after prolonged bonding of 6 months, for example, where the removal must be possible as far as possible without residue and without damaging the printing plates. This operation of removing the printing plates, which in practice is frequently performed manually by operatives, requires the pressure-sensitive adhesive tapes used to ensure ready detachability of the printing plates after the printing operation, so that the operatives deployed are not required to apply excessive force in order to change a printing plate. Further information is disclosed for example in DE 102016213185 A1, EP 3239260 A1, EP 2226372 B1, EP 3838934 A1, EP2867321A1, EP 3272829 A1, EP 2956517 A1, EP 3759188 A1, US 2020392382 A1 or US 20150361307 A1.

One particular feature of this application is that many of the inks used in the printing industry comprise a multiplicity of chemical substances, which may influence the adhesive properties of the pressure-sensitive adhesive tapes used. In particular, many inks comprise cellulose nitrate (sometimes also referred to colloquially as nitrocellulose), which acts as a binder in these inks.

Even in the case of a very rigorous process regime, the reverse sides of the printing plates for bonding, and/or the surfaces of the printing cylinders of corresponding printing apparatuses, are frequently contaminated with such substances as cellulose nitrate. These contaminants are frequently not caused only by splashes of ink or by other instances of direct ink contact, but instead in many cases are also a consequence of the process used for cleaning the printing plates. It is usually the case, indeed, that the printing plates, after being used, are passed through a cleaning bath, which by the time of the second cleaning at the latest also comprises cellulose nitrate. This cleaning bath usually wets the printing plates completely, and so residues of cellulose nitrate remain on all sides of the printing plates.

The presence of cellulose nitrate on the printing plate faces intended for bonding is generally perceived as disadvantageous. The reason is that cellulose nitrate can act as an adhesion promoter between the printing plate and the pressure-sensitive adhesive used, causing a significant increase in the peel adhesion of the PSAs. In practice this means that printing plates bonded with conventional PSAs, after being used, frequently exhibit inadequate detachability from the printing cylinders. As a result, for the operatives deployed, the removal of the printing plates becomes significantly more effortful, as they are required to apply high forces in order to part the printing plates. Furthermore, there may also be disadvantageous effects on the time and cost efficiency of the overall printing operation, if, for example, the apparatuses used must be kept at standstill longer for the purpose of removing the printing plates; if there are instances of damage to the printing plates during detachment, owing to the strong adhesion; and/or if pressure-sensitive adhesive tapes for replacement cannot be parted from the printing cylinders without great effort, as a result, for example, of a cohesive failure promoted by the increased adhesion.

In the field of pressure-sensitive adhesives, poly(meth)acrylates in particular have proven in principle to be very effectively employable base materials. These polymeric compounds generally possess physicochemical properties which predestine them for use in PSAs—for example, a high light stability, resistance to effects of weathering and to a multiplicity of chemicals, and also a high intrinsic peel adhesion and an advantageous ageing resistance. Poly(meth)acrylate-based adhesives, furthermore, can generally be employed across a broad range of substrates, in particular on both polar and less polar substrates, such as on glass and steel, for example, but also on plastics, such as polystyrene or polycarbonates, for example. In the technical field of adhesive technology, accordingly, there is continued interest in enhancing the physicochemical properties of poly(meth)acrylate-based PSAs, particularly their technical adhesive properties.

### SUMMARY OF THE DISCLOSURE

Against this background, poly(meth)acrylate-based PSAs are in principle a PSA highly promising for use in the printing industry as well. In spite of the fundamental advantages of such poly(meth)acrylate-based PSAs, however, the above-described problem of the interaction with cellulose nitrate is frequently perceived as a particular disadvantage with these systems, so reducing their usefulness.

It has been found in connection with this disclosure, moreover, that not only cellulose nitrate but also the presence of titanium chelate compounds, whose use is desirable in certain inks, is problematic for many PSAs. The presence of such titanium chelate compounds may likewise adversely influence the performance properties of PSAs for the bonding of printing plates, and so PSAs known from the prior art for this purpose are occasionally perceived as being insufficient for the application in conjunction with corresponding inks.

The primary object of the present disclosure was to eliminate or at least reduce the disadvantages of the prior art.

An object of the present disclosure in particular was to specify a pressure-sensitive adhesive which exhibits sufficient pressure-sensitive adhesiveness to provide secure fixing of the printing plates used in the printing industry on typical substrates, especially steel and plastics, during usage while at the same time enabling ready detachability of the printing plates and, correspondingly, allowing the adhesive bond to be undone extremely easily. For the secure fixing of the printing plates on the usually curved substrates, there was and is accordingly a particular desire also for advantageous characteristics in the context of edge lifting.

In this context, an object of the present disclosure was that printing plates fixed using corresponding PSAs should be easily demountable in particular even when the PSAs come into contact, during usage, with solvents or other chemicals, especially cellulose nitrate. Accordingly, a further object of the disclosure was that the PSA to be specified ought to remain ensured even on contamination with compounds containing titanium chelate, so as to enable efficient processing of corresponding inks.

A supplementary object of the present disclosure was to specify an advantageous pressure-sensitive adhesive tape and a corresponding use.

### DETAILED DESCRIPTION

It has been found in connection with this disclosure that the objects described above can surprisingly be achieved by using, for the bonding of printing plates, a pressure-sensitive adhesive which comprises or consists, at least in a mass fraction of 30%, of a copolymer which is prepared or preparable from a monomer composition which comprises at least three different monomers in specific mass fractions, as defined in the claims. Using such PSAs and pressure-sensitive adhesive tapes, advantageous bonds with a high printing ink resistance can be achieved, and the corresponding pressure-sensitive adhesive tapes can be used particularly efficiently on curved surfaces, since they display little edge lifting and an advantageous tack for attaching the plates. At the same time, the corresponding PSAs and pressure-sensitive adhesive tapes exhibit advantageous solvent resistance.

The objects stated above are therefore achieved by the subject matter of the disclosure as it is defined in the claims. Preferred configurations in accordance with the disclosure are evident from the dependent claims and from the statements made below.

Those embodiments designated hereinafter as preferred are combined, in particularly preferred embodiments, with features of other embodiments designated as preferred. Especially preferred, accordingly, are combinations of two or more of the embodiments designated hereinafter as particularly preferred. Likewise preferred are embodiments in which a feature of an embodiment that is designated as preferred to any extent is combined with one or more further features of other embodiments which are designated as preferred to any extent. Features of preferred pressure-sensitive adhesive tapes and uses are a product of the features of preferred pressure-sensitive adhesives.

Where, hereinafter, for an element, for example for the constituents of the monomer composition such as the first or second monomers, both specific amounts or fractions of that element and preferred configurations of the element are disclosed, there is also disclosure in particular of the specific amounts or fractions of the elements with preferred configuration. There is also disclosure to the effect that, for the corresponding specific total amounts or total fractions of the elements, at least a part of the elements may have preferred configuration, and also, in particular, there is disclosure to the effect that elements with preferred configuration within the specific total amounts or total fractions may be present in turn in the specific amounts or fractions, respectively.

The disclosure relates in particular to a pressure-sensitive adhesive for bonding printing plates, comprising one or more copolymers in a combined mass fraction of 30% or more, based on the mass of the pressure-sensitive adhesive,

where the one or more copolymers are preparable by polymerizing a monomer composition and optionally subsequently crosslinking the polymers, where the monomer composition, based on the mass of the monomer composition, comprises:
i) one or more first monomers in a combined mass fraction in the range from 5% to 15%, where the first monomers are selected from the group consisting of compounds of the formula I)

CH₂═CR¹—C(O)NR²R³, I)
where R¹ is hydrogen or a methyl group,
where R² is selected from the group consisting of alkyl groups, hydroxyalkyl groups and acetonyl groups and where R³ is selected from the group consisting of hydrogen, alkyl groups, hydroxyalkyl groups, aryl groups, aminoalkyl groups and acetonyl groups, or where R² and R³ together form an organic compound chain, so that NR²R³ is a ring having n ring atoms, where n is in the range from 5 to 8,
ii) one or more second monomers in a combined mass fraction of 70% or more, where the second monomers are selected from the group consisting of compounds of the formula II)

CH₂═CR⁴—C(O)O—R⁵, II)
where R⁴ is hydrogen or a methyl group,
where R⁵ is selected from the group consisting of alkyl groups and aryl groups, and
iii) one or more third monomers in a combined mass fraction in the range from 5% to 15%, where the third monomers are selected from the group consisting of compounds of the formula III)

CH₂═CR⁶—C(O)O—R⁷, III)
where R⁶ is hydrogen or a methyl group,
where R⁷ is selected from the group consisting of hydrogen and hydroxyalkyl groups having 2 to 4 carbon atoms.

The pressure-sensitive adhesives of the disclosure are intended for use in the printing industry and are particularly suitable accordingly for the bonding of printing plates.

A pressure-sensitive adhesive, in agreement with the understanding of the skilled person, is an adhesive which possesses pressure-sensitive adhesive properties, i.e., has the capacity to enter into a durable bond with respect to a substrate even under relatively weak applied pressure. Corresponding pressure-sensitive adhesive tapes are typically redetachable from the substrate substantially without residue after use, and in general have a permanent intrinsic tack even at room temperature, meaning that they have a certain viscosity and touch-tackiness, so that they wet the surface of a substrate even under low applied pressure. The pressure-sensitive adhesiveness of a pressure-sensitive adhesive tape is a product of the use as adhesive of a pressure-sensitive adhesive. Without wishing to be tied to this theory, it is frequently assumed that a pressure-sensitive adhesive may be considered to be a fluid of extremely high viscosity with an elastic component, accordingly having characteristic viscoelastic properties which lead to the above-described durable intrinsic tackiness and pressure-sensitive adhesive capability. It is assumed that with such PSAs, on mechanical deformation, there are viscous flow processes and there is development of elastic forces of resilience. The viscous flow component serves to achieve adhesion, while the elastic forces of resilience component is needed in particular for the achievement of cohesion. The relationships between the rheology and the pressure-sensitive adhesiveness are known in the prior art and described for example in Satas, “Handbook of Pressure Sensitive Adhesive Technology”, Third Edition (1999), pages 153 to 203. To characterize the extent of the elastic and viscous components, it is usual to employ the storage modulus (G′) and the loss modulus (G″), which may be ascertained by dynamic mechanical analysis (DMA), using a rheometer, for example, as disclosed for example in WO 2015/189323. For the purposes of the present disclosure, an adhesive is understood preferably to have pressure-sensitive adhesiveness and hence to be a pressure-sensitive adhesive when at a temperature of 23° C. in the deformation frequency range from 10⁰ to 10¹ rad/sec, G′ and G″ are each situated at least partly within the range from 10³ to 10⁷ Pa.

The pressure-sensitive adhesive of the disclosure comprises copolymers, which in turn are preparable or prepared from various monomers. In agreement with the understanding of a skilled person and with the customary approach in the field of art, it is useful to define polymeric compounds such as the copolymers by way of the preparation process and/or by way of the starting materials used in the preparation, since it is impossible to give a sensible definition of the materials in question otherwise.

The copolymers are presently defined by way of the composition of the monomer composition from which they can be prepared, with the polymers being optionally crosslinkable by chemical crosslinkers. In agreement with the understanding of the skilled person, the constituents of this monomer composition are each used as “one or more”. The designation “one or more” here, in a manner customary in the sector, refers to the chemical nature of the compounds in question and not to their amount of substance. For example, the monomer composition may as the third monomer comprise exclusively acrylic acid, meaning that the monomer composition would comprise a multiplicity of acrylic acid molecules.

In the context of the present disclosure, the expression “(meth)acrylate”, in agreement with the understanding of the skilled person, encompasses acrylates and methacrylates.

The preparation of the copolymers from the monomer composition may take place according to the commonplace processes, especially by conventional radical polymerizations or controlled radical polymerizations. The polymers and/or oligomers may be prepared by copolymerizing the monomeric components using the customary polymerization initiators and also, optionally, chain transfer agents; polymerization may take place at the customary temperatures for example in bulk, in emulsion, such as in water or liquid hydrocarbons, for example, or in solution. Preference is given to a PSA of the disclosure wherein the one or more copolymers are preparable by radical polymerization of the monomer composition, preferably by radical polymerization in solvent or in bulk. With particular preference, the copolymers are prepared by polymerization in solvents, particularly preferably in solvents having a boiling temperature in the range from 50 to 150° C., particularly preferably in the range from 60 to 120° C., using the customary amounts of polymerization initiators; the polymerization initiators are added to the monomer composition generally in a fraction of about 0.01% to 5%, more particularly of 0.1% to 2%, based on the mass of the monomer composition.

Suitable polymerization initiators are, for example, radical sources such as peroxides, hydroperoxides and azo compounds, e.g., dibenzoyl peroxide, cumene hydroperoxide, cyclohexanone peroxide, di-tert-butyl peroxide, cyclohexylsulfonyl acetyl peroxide, diisopropyl percarbonate, tert-butyl peroctoate or benzopinacol. A particularly preferred radical initiator used is 2,2′-azobis(2-methylbutyronitrile) or 2,2′-azobis(2-methylpropionitrile). Solvents suitable include, in particular, alcohols such as methanol, ethanol, n-propanol and isopropanol, n-butanol and isobutanol, preferably isopropanol and/or isobutanol, and also hydrocarbons such as toluene and, in particular, benzines having a boiling temperature in the range from 60 to 120° C. In particular it is possible to use ketones, such as acetone, methyl ethyl ketone and methyl isobutyl ketone, for example, and esters, such as ethyl acetate, for example, and also mixtures of these solvents.

In a preferred PSA of the disclosure, the one or more copolymers are preparable by thermally induced or radiation-induced radical polymerization of the monomer composition and optionally subsequent crosslinking of the polymers.

In a particularly preferred PSA of the disclosure, comprising the one or more copolymers as crosslinked copolymers, the crosslinked copolymers are preparable by polymerizing the monomer composition and subsequently crosslinking the polymers obtained by polymerization, where the subsequent crosslinking takes place preferably with a chemical crosslinker.

Preferred in this case is a PSA of the disclosure wherein the chemical crosslinker is selected from the group consisting of polyfunctional epoxides and polyfunctional (meth)acrylates, where the crosslinking preferably takes place radically.

Preferred in a first variant is a PSA of the disclosure wherein the chemical crosslinker is selected from the group consisting of polyfunctional epoxides and is used in a mass fraction in the range from 0.05% to 2.0%, particularly preferably in the range from 0.1% to 1.5%, based on the combined mass of the copolymers.

Preferred in a second variant is a PSA of the disclosure wherein the chemical crosslinker is selected from the group consisting of polyfunctional (meth)acrylates and is used in a mass fraction in the range from 1% to 20%, preferably in the range from 2% to 15%, particularly preferably in the range from 3% to 10%, based on the combined mass of the copolymers.

The disclosure has in this context identified preferred degrees of polymerization which may be set to give particularly advantageous properties. Preferred accordingly is a PSA of the disclosure wherein the one or more copolymers have a weight-average molecular weight M_{w}, measured via gel permeation chromatography GPC, of 500,000 g/mol or more, preferably of 600,000 g/mol or more, particularly preferably of 700,000 g/mol or more. The weight-average molecular weight here is determined by GPC on 100 mL of clear-filtered sample (sample concentration 0.5 g/L). The eluent used is tetrahydrofuran with 0.1% by volume of trifluoroacetic acid. The measurement is made at 25° C. The pre-column used is a Polymer Standards Service (PSS)-SDV, 10 μm, ID 8.0 mm×50 mm column. Separation takes place using PSS-SDV, 5 μm, 103 Å (SN9090201) and also 5 μm, 102 Å (SN9090200) columns each with ID 8.0 mm×300 mm (detection using PSS-SECurity 1260 RID differential refractometer). The flow rate is 0.5 mL per minute. Calibration takes place against PMMA standards (polymethyl methacrylate calibration).

The skilled person understands that the polymerization of the monomer composition results in an optionally crosslinked copolymer in which the monomer units in the polymer chain derive from the monomers of the monomer composition, with these monomer units being present preferably predominantly randomly, particularly preferably completely randomly, in the polymer chain.

In other words, the pressure-sensitive adhesive for the bonding of printing plates, comprising one or more copolymers in a combined mass fraction of 30% or more, based on the mass of the pressure-sensitive adhesive, is an adhesive wherein the one or more copolymers, based on the total mass of the copolymers, comprise:

i. first monomer units in a combined mass fraction in the range from 5% to 15%, where the first monomer units derive from first monomers, as disclosed above,

ii. second monomer units in a combined mass fraction of 70% or more, where the second monomer units derive from second monomers, as disclosed above, and

iii. third monomer units in a combined mass fraction in the range from 5% to 15%, where the third monomer units derive from third monomers, as disclosed above,

where the first monomer units, second monomer units and third monomer units are distributed preferably randomly along the polymer chain, where the copolymers preferably comprise fourth monomer units, where the fourth monomer units derive from chemical crosslinkers, more particularly from polyfunctional epoxides and polyfunctional (meth)acrylates.

Theoretically at least, it is conceivable for PSAs of the disclosure to comprise further constituents, with suitable candidates including, in particular, tackifier resins, i.e., polymeric compounds whose weight-average molecular weight M_{w}, measured via GPC, is typically 20,000 g/mol or less. This flexibility is advantageous, as it enables PSAs of the disclosure to be custom-tailored to the particular requirements of the particular application. Preferred for some applications, therefore, is a PSA of the disclosure wherein the PSA comprises one or more tackifier resins, preferably in a combined mass fraction in the range from 1% to 30%, preferably in the range from 2% to 20%, especially preferably in the range from 3% to 10%, based on the mass of the PSA. An illustrative PSA of the disclosure, accordingly, is one where the one or more tackifier resins are selected from the group consisting of pinene resins and indene resins, rosin and rosin derivatives such as rosin esters, polyterpene resins, terpene-phenol resins, alkylphenol resins, and aliphatic, aromatic and aliphatic-aromatic hydrocarbon resins.

Also preferred, additionally or alternatively, is a PSA of the disclosure wherein the PSA comprises one or more further additives, preferably in a combined mass fraction in the range from 0.1% to 20%, preferably in the range from 0.2% to 15%, especially preferably in the range from 0.5% to 10%, based on the mass of the PSA, where the one or more further additives are preferably selected from the group consisting of ageing inhibitors, light stabilizers, UV absorbers and rheological additives.

It may be seen as a particular advantage of PSAs of the disclosure, however, that even without the use of tackifier resins or further additives, they display excellent properties and are particularly suitable especially for the bonding of printing plates. Accordingly, it is deemed to be particularly advantageous for the PSA of the disclosure to be formed predominantly, preferably very predominantly, more particularly preferably substantially entirely, of the copolymers. Preference is therefore given to a PSA of the disclosure wherein the PSA comprises the one or more copolymers in a combined mass fraction of 50% or more, preferably 70% or more, particularly preferably 90% or more, especially preferably 95% or more, based on the mass of the PSA. Also preferred, additionally or alternatively, correspondingly, is a PSA of the disclosure wherein the combined mass fraction of tackifier resins and/or further additives, preferably of tackifier resins and further additives, in the pressure-sensitive adhesive is 5% or less, preferably 1% or less, particularly preferably 0.1% or less, where the pressure-sensitive adhesive is preferably free of tackifier resins.

In the estimation of the disclosure, in the scope allowed above, i.e., up to a combined total mass fraction of all monomers of 100%, the monomer composition may also comprise further monomers, these being not first monomers, second monomers or third monomers, without having too much of an adverse influence on the advantageous properties of the copolymers for use in the disclosure. On the basis of the experiments in connection with this disclosure, however, it is particularly preferred for the copolymers to be formed as largely as possible from the first monomers, second monomers and third monomers. Particularly preferred against this background is a PSA of the disclosure wherein the monomer composition, based on the mass of the monomer composition, comprises first monomers, second monomers and third monomers in a combined mass fraction of 80% or more, preferably of 90% or more, particularly preferably of 95% or more, especially preferably of 98% or more, more particularly preferably of 99% or more, extremely preferably of substantially 100%.

With regard to the mass fractions, there has been success in identifying, for the first monomers, second monomers and third monomers, particularly preferred ranges in each case that, particularly for use in the bonding of printing plates, produce a particularly favourable performance profile, especially in terms of the technical adhesive properties and the chemical resistance.

What is preferred, indeed, is first a pressure-sensitive adhesive of the disclosure wherein the combined mass fraction of the first monomers in the monomer composition is in the range from 6% to 13%, preferably in the range from 7% to 11%, particularly preferably in the range from 8% to 10%. Also preferred, additionally or alternatively, is a pressure-sensitive adhesive of the disclosure wherein the combined mass fraction of the second monomers in the monomer composition is 75% or more, preferably 80% or more. Preference is given in turn, preferably or alternatively, to a pressure-sensitive adhesive of the disclosure wherein the combined mass fraction of the third monomers in the monomer composition is in the range from 6% to 13%, preferably in the range from 7% to 11%, particularly preferably in the range from 8% to 10%.

It is estimated that, the chemical resistance, in particular, of pressure-sensitive adhesive tapes of the disclosure may be advantageously influenced through the setting of the ratio between the first monomers and the second monomers. Accordingly, the disclosure have succeeded, for the corresponding quotient, in identifying particularly advantageous ranges of values that allow particularly highly performing PSAs of the disclosure to be obtained that are especially suitable for use in the printing industry and in the processing of inks, more particularly ink containing cellulose nitrate and/or ink containing titanium chelate. What is preferred, indeed, is a pressure-sensitive adhesive of the disclosure wherein, in the monomer composition, the quotient formed by dividing the combined mass fraction of the first monomers by the combined mass fraction of the third monomers is 0.8 or more, preferably 1.0 or more, particularly preferably 1.2 or more, and/or wherein, in the monomer composition, the quotient formed by dividing the combined mass fraction of the first monomers by the combined mass fraction of the third monomers is 2.5 or less, preferably 2.0 or less, particularly preferably 1.5 or less.

The first monomers, second monomers and third monomers are defined above such that the positive properties of the copolymers may be realized, it is estimated, for substantially all corresponding monomers; in agreement with the understanding of the skilled person, the corresponding acrylates and methacrylates are used more particularly in each case. However, on the basis of experiments leading up to the present disclosure, there has been success, for the first monomers, second monomers and third monomers, in identifying particularly preferred compounds in each case that allow advantageous copolymers to be obtained which are particularly suitable for use in PSAs of the disclosure.

The first monomers comprise an amide group which is estimated to be necessary; moreover, the radicals R² and R³ disposed on the amide can be chosen fairly freely, and it is also possible for NR²R³ to be a ring, so that-R²-R³-is a chain that attaches by the two free valencies to the nitrogen atom. Preferred in this context is a pressure-sensitive adhesive of the disclosure wherein the first monomers are selected from the group consisting of compounds of the formula I) where R² is selected from the group consisting of alkyl groups, preferably having 1 to 10 carbon atoms, particularly preferably having 1 to 6 carbon atoms, and where R³ is selected from the group consisting of hydrogen and alkyl groups, preferably having 1 to 10 carbon atoms, particularly preferably having 1 to 6 carbon atoms, or where R² and R³ together form an organic compound chain, so that NR²R³ is a six-membered ring. Particularly preferred in this context is a pressure-sensitive adhesive of the disclosure wherein the first monomers are selected from the group consisting of compounds of the formula I) where R² is selected from the group consisting of alkyl groups, preferably having 1 to 10 carbon atoms, particularly preferably having 1 to 6 carbon atoms, and where R³ is selected from the group consisting of hydrogen and alkyl groups, preferably having 1 to 10 carbon atoms, particularly preferably having 1 to 6 carbon atoms, where R² and R³ are preferably identical.

Preferred in principle is a pressure-sensitive adhesive of the disclosure wherein the first monomers are selected from the group consisting of compounds of the formula I) where R¹ is hydrogen.

Fundamentally preferred, additionally or alternatively, is a pressure-sensitive adhesive of the disclosure wherein the first monomers are selected from the group consisting of dimethylacrylamide, N-t-butylacrylamide and N-acryloylmorpholine, preferably selected from the group consisting of dimethylacrylamide and N-t-butylacrylamide, particularly preferably dimethylacrylamide.

The second monomers form the constituent of the monomer composition having the largest mass fraction. For this, it is necessary in accordance with the disclosure to employ (meth)acrylates having non-polar radicals, which in particular carry no further functional groups. Preferred in this context is a pressure-sensitive adhesive of the disclosure wherein the second monomers are selected from the group consisting of compounds of the formula II) where R⁵ is selected from the group consisting of alkyl groups, preferably alkyl groups having 2 to 10 carbon atoms, preferably having 3 to 9 carbon atoms, particularly preferably having 4 to 8 carbon atoms.

Preferred in principle is a pressure-sensitive adhesive of the disclosure wherein the second monomers are selected from the group consisting of compounds of the formula II) where R⁴ is hydrogen.

Fundamentally preferred is a pressure-sensitive adhesive of the disclosure wherein the second monomers are selected from the group consisting of butyl (meth)acrylate and ethylhexyl (meth)acrylate, preferably selected from the group consisting of butyl acrylate and ethylhexyl acrylate.

With regard to the second monomers, it has proven to be advantageous, for optimal establishment of the desired physicochemical properties of the copolymers, for various second monomers to be combined with one another. Preferred accordingly is a pressure-sensitive adhesive of the disclosure wherein the monomer composition comprises two or more second monomers.

The third monomers carry an acidic functionality, with a particular surprise being that such advantageous polymers and pressure-sensitive adhesives are obtainable with the specified concentrations of acidic monomers, such as (meth)acrylic acid, for example, which fundamentally are situated above the mass fractions that a skilled person would customarily use in typical polymers for use in the bonding of printing plates.

Particularly preferred is a pressure-sensitive adhesive of the disclosure wherein the third monomers are selected from the group consisting of compounds of the formula III) where R⁷ is hydrogen.

Preferred in principle is a pressure-sensitive adhesive of the disclosure wherein the third monomers are selected from the group consisting of compounds of the formula III) where R⁶ is hydrogen.

A particular instance of additives which serve for adjusting the properties of PSAs are insoluble fillers which may be added to the PSA to obtain a filled PSA. These fillers are particulate fillers having a mean particle diameter (D50) of 5 μm or more, preferably 10 μm or more, particularly preferably 20 μm or more, which are insoluble in the PSA and which are present therein, accordingly, as a dispersion, and also macroscopic fillers such as fibres, for example. The insoluble fillers are preferably selected from the group consisting of particulate fillers. With particular preference, the insoluble fillers are selected from the group consisting of expandable hollow polymer spheres, non-expandable hollow polymer spheres, solid polymer spheres, hollow glass spheres, solid glass spheres, hollow ceramic spheres, solid ceramic spheres and/or solid carbon spheres. Examples of candidate insoluble fillers also, however, include fibres, laid scrims, small plates and small rods of materials insoluble in the PSA. As a result of their in some cases already macroscopic dimensions and of the absence of solubility, these materials have substantially no influence on the above-disclosed circumstances of the compositional chemistry of the PSA, but instead are present in a heterogeneous mixture with the PSA. Correspondingly, in the context of the present disclosure, these insoluble fillers are not considered part of the PSA and accordingly are not included in the calculation of mass fractions relative to the mass of the PSA. In the context of the present disclosure, the definition instead is that the addition of insoluble fillers to a PSA of the disclosure results in a filled PSA, i.e., a filled PSA comprising:

x) a pressure-sensitive adhesive of the disclosure, preferably as disclosed above as preferred, and

y) one or more insoluble fillers.

The combined mass fraction of the insoluble fillers here is preferably in the range from 1% to 50%, particularly preferably in the range from 2% to 40%, especially preferably in the range from 5% to 30%.

PSAs of the disclosure may be used, for example, directly as adhesives, in which case they may also be provided in the form of tapes, for example, according to method of application. With a view to extremely favourable handling qualities, however, particularly advantageous results are regularly achieved when PSAs of the disclosure are used as an adhesive layer of a single-sided or double-sided pressure-sensitive adhesive tape which, moreover, comprises a carrier layer. For the securing of printing plates, more particular preference is given to double-sided pressure-sensitive adhesive tapes employing a PSA of the disclosure on both sides. The disclosure also relates to a pressure-sensitive adhesive tape, more particularly double-sided pressure-sensitive adhesive tape, comprising a carrier layer and an adhesive layer disposed on the carrier layer, where the adhesive layer comprises or consists of a pressure-sensitive adhesive of the disclosure.

The term “adhesive tape” is clear to the person skilled in the art of adhesive bonding technology. In the context of the present disclosure, the expression “tape” designates all thin sheetlike structures, i.e., structures having a predominant extent in two dimensions, more particularly films, film portions and labels, preferably tapes with extended length and limited width, and also corresponding tape portions.

The carrier layer usually designates that layer of a multi-layer adhesive tape of this kind that critically determines the mechanical and physical properties of the adhesive tape, such as the tear resistance, stretchability, insulation capacity or resilience, for example. Examples of customary materials for the carrier layer are woven fabrics, laid scrims and polymeric films, for example PET films and polyolefin films. In a preferred pressure-sensitive adhesive tape of the disclosure, the carrier layer comprises a plastic or consists of a plastic, preferably polyethylene terephthalate or polypropylene (PP).

The carrier layer, however, may also itself be pressure-sensitively adhesive. The pressure-sensitive adhesive tape of the disclosure may in one particularly preferred embodiment be a double-sided pressure-sensitive adhesive tape whose carrier layer is furnished on both sides with a PSA of the disclosure. In pressure-sensitive adhesive tapes of the disclosure, the adhesive layers may be lined with what is called a release liner, in order to enable trouble-free unwinding and to protect the PSA from fouling. Such release liners customarily consist of a single-sidedly or double-sidedly siliconized polymeric film (e.g., PET or PP) or of a siliconized paper carrier.

The disclosure lastly also relates to the use of a pressure-sensitive adhesive of the disclosure or of a pressure-sensitive adhesive tape of the disclosure for securing printing plates, more particularly flexible printing plates, on a printing cylinder or a printing sleeve, for improving the detachability of the printing plates in the processing of ink, more particularly ink containing cellulose nitrate and/or ink containing titanium chelate.

Preferred here is a use in accordance with the disclosure wherein the ink is an ink containing cellulose nitrate, preferably an ink containing cellulose nitrate and containing titanium chelate.

Further disclosed is a process for producing pressure-sensitive adhesives of the disclosure, comprising the process steps of:

aa) preparing or providing a monomer composition comprising one or more first monomers in a combined mass fraction in the range from 5% to 15%, one or more second monomers in a combined mass fraction of 70% or more, and one or more third monomers in a combined mass fraction in the range from 5% to 15%,

bb) polymerizing the monomer composition, preferably via radical polymerization, especially preferably thermally initiated radical polymerization,

and optionally the process step of:

cc) crosslinking the polymers obtained in process step bb) by a chemical crosslinker, preferably by means of epoxide compounds,

and additionally optionally the process step of:

dd) mixing the polymers obtained in process step bb) or the crosslinked polymers obtained in process step cc) with further constituents, more particularly tackifier resins and/or further additives.

Below, the disclosure and preferred embodiments of the disclosure are further elucidated and described with reference to experiments.

### A. Preparation of the Copolymers:

### Radical Solution Polymerization in a Batch Reactor:

Radical solution polymerization in a batch reactor took place in a 5 L glass reactor which was charged with monomers and solvents according to Table 2 (below). The total mass used was 800 g. The monomer: solvent ratio was 1:1. After nitrogen gas had been passed through the reactor with stirring for 45 minutes, the reactor was heated up to 58° C. and the reaction was initiated with addition of 4 g of a 5 wt % 2,2′-azodi(2-methylbutyronitrile) solution (trade name Vazo™ 67, from DuPont) in acetone. This was followed by an isothermal regime at 62° C. for two hours. One hour after the initiation of reaction, a further 4 g of a 5 wt % 2,2′-azodi(2-methylbutyronitrile) solution were added. After the end of the isothermal procedure, a switch is made to an isoperibol up to the end of process. After reaction times of 5 hours and 30 minutes and of 7 hours, 12 g on each occasion of a 5 wt % bis(4-tert-butylcyclohexyl) peroxydicarbonate solution (trade name Perkadox® 16, from Akzo Nobel) in acetone were added. The reaction was at an end after a reaction time of 24 h. Depending on the monomer composition employed, dilution took place up to 5 times, based on the increase in viscosity, with 80 g in each case of the solvent used. The k value for the polymers prepared is greater than 45. In a separate vessel, crosslinkers (crosslinker amount and type according to Table 2) and solvents are added to the polymer to achieve a solids fraction of 30 wt %.

### Radical Solution Polymerization in a Semi-Batch Reactor:

Radical solution polymerization in a semi-batch reactor took place in a 2 L glass reactor which was charged with monomers and solvents according to Table 2. The total mass used (initial reactor charge and feed) was 500 g. The monomer: solvent ratio was 3:2 both in the initial reactor charge and in the feed. The initial charge to the reactor is 200 g. After nitrogen gas had been passed through the reactor with stirring for 45 minutes, the reactor was heated up to 58° C. and the reaction was initiated with addition of 5 g of a 5 wt % 2,2′-azodi(2-methylbutyronitrile) solution (trade name Vazo™ 67, from DuPont) in acetone. When the temperature maximum had been reached, 300 g of the monomer-solvent mixture were metered in over 2h and the internal reactor temperature was set to 72° C. The system is thereafter switched to an isoperibol regime at a temperature of 80° C. After reaction times of 0.5 and 1 hour, additions were made of 4 g in each case of a 5 wt % 2,2′-azodi(2-methylbutyronitrile) solution (trade name Vazo™ 67, from DuPont) in acetone. Subsequently, after reaction times of 6 and 7.5 hours, additions are made respectively of 15 and 10 g of a 5 wt % bis(4-tert-butylcyclohexyl) peroxydicarbonate solution (trade name Perkadox®, from Akzo Nobel) in acetone. The reaction was at an end after a reaction time of 10 h. Depending on the monomer composition employed, dilution took place up to 5 times, based on the increase in viscosity, with 60 g in each case of the solvent used. The k value for the polymers prepared is greater than 45. In a separate vessel, crosslinkers (crosslinker amount and type according to Table 2) and solvents are added to the polymer to achieve a solids fraction of 30 wt %.

### Radical Bulk Polymerization

The copolymers are prepared via UV polymerization in two steps. In the first, a UV syrup is prepared. For this purpose, the monomers according to Table 2 are mixed together with 0.0063 wt % of 1,2-diphenyl-2,2-dimethoxyethanone (trade name Irgacure® 651). Before the start of reaction, nitrogen gas is passed through the system with stirring for 20 min. The total mass of the reaction mixture was 500 g. With an intensity of 0.5 mW/cm², the reaction mixture is irradiated to a conversion of 7%. In the second step, this reaction mixture is admixed and stirred homogeneously together with a dielectric and/or crosslinker according to Table 2 and 0.12 wt % of Irgacure® 651. This UV syrup mixture is coated out between two transparent liners and polymerized from both sides using an irradiation programme comprising the following irradiation steps, indicated as blocks [I]/[t] where I is the intensity in (mW/cm²) and t is the duration in seconds: [0.8]/[15]; [12.8]/[150]; [0]/[30]; [8]/[150]; [0]/[30]; [0.8]/[30]; [0]/[30]; [0.8]/[30]; [0]/[30]; [0.8]/[30]; [0]/[30]; [0.8]/[15]; [0]/[30]; [0.8]/[15]; [0]/[30]; [0.8]/[15]; [0]/[30]. A tape with a coat weight of 35 g/cm² was produced. The total mass of the UV syrup mixture was 150 g.

TABLE 1
Monomers and crosslinkers used

| Abbrev. | Monomer |
|---|---|
| AA | acrylic acid |
| BA | n-butyl acrylate |
| EHA | 2-ethylhexyl acrylate |
| IBOA | isobornyl acrylate |
| IOA | isooctyl acrylate |
| DMAA | N,N-dimethylacrylamide |
| ACMO | N-acryloylmorpholine |
| NtBAM | N-t-butylacrylamide |
| Erisys | N,N,N′,N′-tetrakis(2,3-epoxypropyl)-m-xylene-α,α′-diamine, |
| | trade name: Erisys ® GA-240, from Huntsman |
| Uvacure | 3,4-epoxycyclohexylmethyl 3′,4′-epoxycyclohexanecarboxylate, |
| | trade name: Uvacure ® 1500, from Solvay |
| HDDA | hexanediol diacrylate |
| S610 | N,N,N′,N′-tetrakis(2,3-epoxypropyl)cyclohexane-1,3- |
| | dimethylamine, trade name: S610, from Synasia |

TABLE 2
Copolymers prepared

| | Polym. | | | |
|---|---|---|---|---|
| No. | technique | Solvents^{a)} | Monomers^{b)} | Crosslinkers^{c)} |
| I1 | Solution | benzine/acetone | AA 8; DMAA 10; | Erisys 0.35 |
| | (Batch) | (50:50) | BA 27; EHA 55 | |
| I2 | Solution | benzine/acetone | AA 8; DMAA 10; | Uvacure 1.4 |
| | (Batch) | (50:50) | BA 27; EHA 55 | |
| I3 | Solution | benzine/acetone | AA 10; DMAA 10; | Erisys 0.25 |
| | (Batch) | (50:50) | BA 27; EHA 53 | |
| I4 | Solution | benzine/acetone | AA 8; ACMO 8; | Erisys 0.3 |
| | (Batch) | (50:50) | BA 28; EHA 56 | |
| I5 | Solution | benzine/acetone | AA 6; NtBAM 8; | Erisys 0.3 |
| | (Batch) | (50:50) | BA 29; EHA 57 | |
| I6 | Solution | ethyl acetate/ | AA 8; DMAA 10; | Uvacure 1.3 |
| | (Semi-batch) | isopropanol (97:3) | BA 27; EHA 55 | |
| I7 | Bulk | — | AA 8; DMAA 10; | HDDA 5 |
| | | | BA 27; EHA 55 | |
| I8 | Bulk | — | AA 8; DMAA 10; | HDDA 10 |
| | | | BA 27; EHA 55 | |
| C1 | Solution | benzine/acetone | AA 1; DMAA 11; | S610 0.3 |
| | (Batch) | (50:50) | BA 27; EHA 61 | |
| C2 | Solution | benzine/acetone | AA 3; DMAA 9; | Erisys 0.3 |
| | (Batch) | (50:50) | BA 29; EHA 59 | |
| C3^{d}) | Solution | benzine/acetone | AA 5.5; IBOA 27; | Erisys 0.3 |
| | (Batch) | (50:50) | IOA 67.5 | |
| C4^{d)} | Solution | benzine/acetone | AA 12.5; IBOA | Erisys 0.3 |
| | (Batch) | (50:50) | 22.5; IOA 65 | |

^{a)}solvent composition as ratio by mass;
^{b)}all data in mass fractions based on the total mass of the monomers;
^{c)}all data in mass fractions based on the solids content of the polymer;
^{d)}polymer composition analogous to US 20150361307A1 (as example of systems with high levels of AA that are fairly untypical in the prior art).

### B. Production of Pressure-Sensitive Adhesive Tapes and Preparation of Printing Cylinders:

The pressure-sensitive adhesive tapes under investigation were produced as follows, depending on the preparation of the copolymers.

The PSAs from solution polymerization were each knife-coated out onto a liner (SILPROP KA 110 B XRX0384/XRX0415). After drying at 80° C. for 20 minutes, the adhesive coat weight was 35 g/m².

In the case of the result of the bulk polymerization, which was already in tape form, the release liner is detached and further processing took place as for the solution polymerization.

On the adhesive side, the coated liner material was laminated with a PET film 19 mm thick and etched on both sides using trichloroacetic acid. Subsequently, by way of a transfer carrier, a commercial acrylate compound was laminated with a coat weight of 20 g/m² onto the uncoated side of the etched PET film in the laminate and a PE-EVA foam having a thickness of 500 mm and a density of 250 kg/m³ was laminated on; subsequently, a commercial acrylate compound was again applied with a coat weight of 20 g/m² to the facing side of the foam. From the respective double-sided pressure-sensitive adhesive laminate generated in this way, a specimen was cut that measured 250 mm×160 mm.

The specimens produced are each bonded by the standard commercial, exposed pressure-sensitive acrylate adhesive layer to a cylinder having a diameter of 110 mm in such a way that the shorter edges of the specimens are aligned in the longitudinal direction of the cylinder. The liner is subsequently removed, thus exposing the layer of the PSA for use in the disclosure. Adhered to the thus-bonded pressure-sensitive adhesive laminate specimen is a printing plate from DuPont Cyrel® HOS which has undergone full-area exposure and has dimensions of length 210 mm×width 120 mm×thickness 1.7 mm, the adhering taking place to the PSA for inventive use in such a way that there are 20 mm of the underlying pressure-sensitive adhesive laminate overhanging at each edge (centred application on the pressure-sensitive adhesive laminate specimen). The plate is aligned parallel to the top edge of the PSA laminate. Beforehand, the PET side of the plate was cleaned with isopropanol and left to dry in the air for 5 minutes so that the solvent could evaporate off completely.

Subsequently, starting from the top plate edge, the plate was rolled on with a rubber roller (width 100 mm, diameter 30 mm, Shore hardness A 45). The rolling movement took place in the longitudinal direction of the printing cylinder and was performed continuously from each long edge of the plate to the opposite long edge of the plate and back again. The rolling speed here in transverse direction was 10 m/min. At the same time, the printing cylinder rotated at a surface speed of 0.6 m/min, causing the rubber roller to describe, relative to the printing plate, a zigzag movement in the direction of the second transverse edge of the plate. The plate was mounted onto the pressure-sensitive laminate with the appropriate pressing force needed to fix the plate over the full area and without edge lifting.

As further comparative examples C5 and C6, two commercially available pressure-sensitive adhesive tapes were used, namely the commercial product “Plus Plate Mounting Tape 1020” from 3M (C5) and the commercial product DuploFlex® 5.2 Plus from Lohmann (C6). These tapes were secured on the printing cylinder in a manner analogous to the procedure described above.

### C. Test Methods:

### Test Method 1 (TM1)—Printing Ink Resistance

To obtain plates contaminated with printing inks, a piece of cellulose with dimensions of length 30 mm×width 30 mm×thickness 4 mm was used to coat the PET side of the plates, cleaned as described above, additionally with 5 mL of a printing ink solution comprising a commercially available printing ink (trade name: Siegwerk DMO 40, containing cellulose nitrate and titanium chelate, the printing ink having been selected in quality overview trials such that it ought to show a maximum of reactivity with respect to the adhesives used) in solution in 100 mL of ethanol, employing either a solution having a high concentration of printing ink (120 g/100 mL; HC) or one with a low concentration of printing ink (60 g/100 mL; LC). Coating took place in stripes, first horizontally, with the plate being wetted over its full area with the solution. The plate was subsequently coated using the same piece of cellulose a second time, this time in vertical direction. The plate was then stored in the air for 1 minute so that the solvent could evaporate off. The contaminated plate is bonded as for the test set-up described above. The cylinder was stored for 72 hours at 40° C. with the respective pressure-sensitive adhesive tape and the respective bonded plate, perpendicularly on one of its end faces.

The interaction between printing ink and PSA was evaluated in terms of quality. The subjective force that needed to be applied in order to demount the respective plates is assessed by an experienced operative. Demounting is carried out standing, with the feet at shoulder width apart. The plate is grasped in both hands at an edge extending in the longitudinal direction of the steel cylinder, and is pulled off at about 300 mm/min in the transverse direction relative to the steel cylinder (radially).

Force application and detachment characteristics are evaluated using a qualitative evaluation scale which is utilized in the sector and runs from 1 to 5 (1: very easy, 2: casy, 3: acceptable, 4: hard, 5: very hard). Cohesive fracture during detachment is given an evaluation of 5.

### Test Method 2 (TM2)—Edge Lifting of Clean Plates

Following the preparation of the printing cylinders as above, the resulting constructions with the respective pressure-sensitive adhesive tape and the respective bonded plate are stored for 72 hours, standing perpendicularly on one of their end faces, under different conditions, specifically at i) 23° C. and 50% relative humidity (rh), ii) 40° C. and 50% relative humidity or ii) 35° C. and 85% relative humidity. Measurement was preceded by acclimatization for 1 hour at 23° C. and 50% relative humidity.

The quality of adhesive bonding was evaluated by way of the measurement of edge lifting, i.e., of independent detachment of the plates from the adhesive tape under various influencing conditions, with low values corresponding to advantageous bonding quality.

### Test Method 3 (TM3)—Solvent Test

The plate is bonded in analogy to the procedure described above. A solution consisting of (in mass fractions in each case) 75% ethanol, 12.5% ethyl acetate and 12.5% n-propanol was applied to the edges of the plates according to the test set-up. After a minute and an hour, the edge lifting was measured. Evaluation took place as indicated above.

### Test Method 4 (TM4)—Tack Determination

The pressure-sensitive adhesive tape for testing is adhered to a cylinder having a diameter of 110 mm such that the shorter edges of the specimens are aligned in the longitudinal direction of the cylinder. Placed onto the thus-bonded pressure-sensitive adhesive laminate specimen is a printing plate from DuPont Cyrel® HOS which has undergone full-area exposure and has dimensions of length 210 mm×width 120 mm×thickness 1.7 mm, placement being performed at an angle of 90° perpendicularly to the pressure-sensitive adhesive film. The printing plate must adhere on the pressure-sensitive adhesive laminate specimen without the exertion of additional pressure onto the bonding area. The quality of the relevant property was evaluated by an experienced operative as adequate (A) or not adequate (NA).

### D. Results:

The results of the tests conducted on the PSAs of the disclosure and the comparative examples are summarized in Table 3 below.

TABLE 3
Results of the tests conducted (n.d. = not determined)

| | | | TM2 | | | | | |
|---|---|---|---|---|---|---|---|---|
| | TM1 | | 23° C.; | 40° C.; | 35° C.; | TM3 | | TM4 |
| No. | HC | LC | 50% rh | 50% rh | 85% rh | 1 min | 1 h | Tack |
| I1 | 2 | 1 | 0 | 0 | 4 | 0 | 7 | A |
| I2 | 1 | 1 | 0 | 1 | 16 | 1 | 4 | A |
| I3 | 1 | 1 | 0 | 0 | 7 | 0 | 2 | A |
| I4 | 3 | 2 | 0 | 7 | 24 | 2 | 15 | A |
| I5 | 1 | 1 | 1 | 7 | 17 | 1 | 30 | A |
| I6 | 2 | 1 | 3 | 6 | 22 | 0 | 14 | A |
| I7 | 3 | 2 | 0 | 0 | 10 | 1 | 13 | A |
| I8 | 1 | 1 | 1 | 1 | 18 | 1 | 17 | A |
| C1 | 5 | 4 | 0 | 0 | 1 | 13 | 90 | A |
| C2 | 3 | 3 | 9 | 23 | 46 | 37 | 86 | A |
| C3 | 5 | 5 | n.d. | n.d. | n.d. | n.d. | n.d. | A |
| C4 | 3 | 3 | n.d. | n.d. | n.d. | n.d. | n.d. | A |
| C5 | 4 | 3 | 3 | 4 | 6 | 2 | 10 | NA |
| C6 | 5 | 4 | 2 | 2 | 10 | 22 | 45 | A |

The results compiled in Table 3 confirm that all of the PSAs of the disclosure are suitable advantageously for use in the bonding of printing plates.

The PSAs of the disclosure display satisfactory to excellent resistance to printing ink, even at high concentrations. Moreover, in spite of a wide variety of different stresses, the PSAs of the disclosure exhibit advantages in edge lifting and the necessary tack.

All in all, the PSAs of the disclosure resolve the conflict of objectives that exists in the bonding of printing plates, between the opposing requirements of on the one hand a sufficiently strong adhesive bond, easily produced as a result of the tack, and on the other hand an easy detachability, and do so in a particularly advantageous way, so being superior in their overall performance profile to the comparative examples, which display favourable properties, if at all, only in isolated partial aspects.

As a result, PSAs of the disclosure allow the printing plates used in the printing industry to be fixed securely and with little edge lifting on typical substrates, especially steel and plastics, during usage but at the same time ensure that the printing plates can be readily detached and, correspondingly, that the adhesive bond can be undone extremely easily, even after exposure to a variety of typical application stress scenarios.

According to a first aspect of the present disclosure, a pressure-sensitive adhesive for bonding printing plates, comprising one or more copolymers in a combined mass fraction of 30% or more, based on a mass of the pressure-sensitive adhesive, where the one or more copolymers are prepared by polymerizing a monomer composition, where the monomer composition, based on a mass of the monomer composition, comprises: (i) one or more first monomers in a combined mass fraction in the range from 5% to 15%, where the one or more first monomers are selected from the group consisting of compounds of the formula I) CH₂═CR¹—C(O)NR²R³, where R¹ is hydrogen or a methyl group, where R² is selected from the group consisting of alkyl groups, hydroxyalkyl groups and acetonyl groups and where R³ is selected from the group consisting of hydrogen, alkyl groups, hydroxyalkyl groups, aryl groups, aminoalkyl groups and acetonyl groups, or where R² and R³ together form an organic compound chain, so that NR²R³ is a ring having n ring atoms, where n is in the range from 5 to 8, (ii) one or more second monomers in a combined mass fraction of 70% or more, where the one or more second monomers are selected from the group consisting of compounds of the formula II) CH₂═CR⁴—C(O)O—R⁵, where R⁴ is hydrogen or a methyl group, where R⁵ is selected from the group consisting of alkyl groups and aryl groups, and (iii) one or more third monomers in a combined mass fraction in the range from 5% to 15%, where the one or more third monomers are selected from the group consisting of compounds of the formula III) CH₂═CR⁶—C(O)O—R⁷, where R⁶ is hydrogen or a methyl group, where R⁷ is selected from the group consisting of hydrogen and hydroxyalkyl groups having 2 to 4 carbon atoms.

According to a second aspect of the present disclosure, the pressure-sensitive adhesive of the first aspect is presented, wherein the pressure-sensitive adhesive comprises the one or more copolymers in a combined mass fraction of 50% or more, based on the mass of the pressure-sensitive adhesive.

According to a third aspect of the present disclosure, the pressure-sensitive adhesive of any one of the first through second aspects is presented, wherein (i) the one or more copolymers are crosslinked copolymers, and (ii) the crosslinked copolymers are prepared by polymerizing the monomer composition and subsequently crosslinking the polymers obtained by polymerization, the subsequent crosslinking taking place with a chemical crosslinker.

According to a fourth aspect of the present disclosure, the pressure-sensitive adhesive of the third aspect is presented, wherein the chemical crosslinker is selected from the group consisting of polyfunctional epoxides and polyfunctional (meth)acrylates.

According to a fifth aspect of the present disclosure, the pressure-sensitive adhesive of any one of the first through fourth aspects is presented, wherein the combined mass fraction of the one or more first monomers in the monomer composition is in the range from 6% to 13%.

According to a sixth aspect of the present disclosure, the pressure-sensitive adhesive of any one of the first through fifth aspects is presented, wherein the combined mass fraction of the one or more second monomers in the monomer composition is 75% or more.

According to a seventh aspect of the present disclosure, the pressure-sensitive adhesive of any one of the first through sixth aspects is presented, wherein the combined mass fraction of the one or more third monomers in the monomer composition is in the range from 6% to 13%.

According to an eighth aspect of the present disclosure, the pressure-sensitive adhesive of any one of the first through seventh aspects is presented, wherein, in the monomer composition, a quotient formed by dividing the combined mass fraction of the one or more first monomers by the combined mass fraction of the one or more third monomers is within a range of from 0.8 to 2.5.

According to a ninth aspect of the present disclosure, the pressure-sensitive adhesive of any one of the first through eighth aspects is presented, wherein the one or more first monomers are selected from the group consisting of dimethylacrylamide, N-t-butylacrylamide, and N-acryloylmorpholine.

According to a tenth aspect of the present disclosure, the pressure-sensitive adhesive of any one of the first through ninth aspects is presented, wherein the one or more second monomers are selected from the group consisting of butyl (meth)acrylate, ethylhexyl (meth)acrylate, isobornyl acrylate, and isooctyl acrylate.

According to an eleventh aspect of the present disclosure, the pressure-sensitive adhesive of any one of the first through tenth aspects is presented, wherein the one or more third monomers consists of acrylic acid.

According to a twelfth aspect of the present disclosure, the pressure-sensitive adhesive of any one of the first through eleventh aspects is presented, wherein (i) the one or more first monomers are selected from the group consisting of dimethylacrylamide, N-t-butylacrylamide, and N-acryloylmorpholine, (ii) the one or more second monomers are selected from the group consisting of butyl (meth)acrylate, ethylhexyl (meth)acrylate, isobornyl acrylate, and isooctyl acrylate, and (iii) the one or more third monomers consists of acrylic acid.

According to a thirteenth aspect of the present disclosure, the pressure-sensitive adhesive of the twelfth aspect is presented, wherein the mass fraction of the acrylic acid in the monomer composition is within a range of from 5% to 15%.

According to a fourteenth aspect of the present disclosure, the pressure-sensitive adhesive of the thirteenth aspect is presented, wherein (i) the one or more copolymers are one or more cross-linked copolymers, and (ii) the one or more cross-linked copolymers are prepared by crosslinking the one or more copolymers with a chemical crosslinker.

According to a fifteenth aspect of the present disclosure, the pressure-sensitive adhesive of the thirteenth aspect is presented, wherein (i) the combined mass fraction of the one or more first monomers in the monomer composition is within a range of from 5% to 15%, and (ii) the combined mass fraction of the one or more second monomers in the monomer composition is within a range of from 70% to 90%.

According to sixteenth aspect of the present disclosure, a pressure sensitive adhesive tape comprises: (A) a carrier layer; and (B) an adhesive layer on the carrier layer, the adhesive layer comprising a pressure-sensitive adhesive, the pressure-sensitive adhesive comprising: a pressure-sensitive adhesive for bonding printing plates, comprising one or more copolymers in a combined mass fraction of 30% or more, based on the mass of the pressure-sensitive adhesive, where the one or more copolymers are prepared by polymerizing a monomer composition, where the monomer composition, based on the mass of the monomer composition, comprises: i) one or more first monomers in a combined mass fraction in the range from 5% to 15%, where the one or more first monomers are selected from the group consisting of compounds of the formula I) CH₂═CR¹—C(O)NR²R³, where R¹ is hydrogen or a methyl group, where R² is selected from the group consisting of alkyl groups, hydroxyalkyl groups and acetonyl groups and where R³ is selected from the group consisting of hydrogen, alkyl groups, hydroxyalkyl groups, aryl groups, aminoalkyl groups and acetonyl groups, or where R² and R³ together form an organic compound chain, so that NR²R³ is a ring having n ring atoms, where n is in the range from 5 to 8, ii) one or more second monomers in a combined mass fraction of 70% or more, where the second monomers are selected from the group consisting of compounds of the formula II) CH₂═CR⁴—C(O)O—R⁵, where R⁴ is hydrogen or a methyl group, where R⁵ is selected from the group consisting of alkyl groups and aryl groups, and iii) one or more third monomers in a combined mass fraction in the range from 5% to 15%, where the third monomers are selected from the group consisting of compounds of the formula III) CH₂═CR⁶—C(O)O—R⁷, where R⁶ is hydrogen or a methyl group, where R⁷ is selected from the group consisting of hydrogen and hydroxyalkyl groups having 2 to 4 carbon atoms.

According to a seventeenth aspect of the present disclosure, the pressure sensitive adhesive tape of the sixteenth aspect is presented, wherein (i) the one or more copolymers are crosslinked copolymers, and (ii) the crosslinked copolymers are prepared by polymerizing the monomer composition and subsequently crosslinking the polymers obtained by polymerization, the subsequent crosslinking taking place with a chemical crosslinker.

According to an eighteenth aspect of the present disclosure, the pressure sensitive adhesive tape of any one of the sixteenth through seventeenth aspects is presented, wherein (i) the combined mass fraction of the one or more first monomers in the monomer composition is in the range from 5% to 15%, (ii) the combined mass fraction of the one or more second monomers in the monomer composition is 75% or more, and (iii) the combined mass fraction of the one or more third monomers in the monomer composition is in the range from 5% to 15%.

According to a nineteenth aspect of the present disclosure, the pressure sensitive adhesive tape of any one of the sixteenth through eighteenth aspects is presented, wherein (i) the one or more first monomers are selected from the group consisting of dimethylacrylamide, N-t-butylacrylamide, and N-acryloylmorpholine, (ii) the one or more second monomers are selected from the group consisting of butyl (meth)acrylate, ethylhexyl (meth)acrylate, isobornyl acrylate, and isooctyl acrylate, and (iii) the one or more third monomers consists of acrylic acid.

According to a twentieth aspect of the present disclosure, a method of flexographic printing comprises: (A) securing a flexible printing plate on a printing cylinder or a printing sleeve with a pressure-sensitive adhesive tape, the pressure-sensitive adhesive tape comprising a pressure-sensitive adhesive, (B) conducting a printing operation with the flexible printing plate secured onto the printing cylinder or the printing sleeve and with ink that comprises cellulose nitrate or titanium chelate, and (C) removing the flexible printing plate from the printing cylinder or the printing sleeve, wherein, the pressure-sensitive adhesive comprises one or more copolymers in a combined mass fraction of 30% or more, based on a mass of the pressure-sensitive adhesive, the one or more copolymers are prepared by polymerizing a monomer composition, the monomer composition, based on a mass of the monomer composition, comprises: (i) one or more first monomers in a combined mass fraction in the range from 5% to 15%, where the one or more first monomers are selected from the group consisting of compounds of the formula I) CH₂═CR¹—C(O)NR²R³, where R¹ is hydrogen or a methyl group, where R² is selected from the group consisting of alkyl groups, hydroxyalkyl groups and acetonyl groups and where R³ is selected from the group consisting of hydrogen, alkyl groups, hydroxyalkyl groups, aryl groups, aminoalkyl groups and acetonyl groups, or where R² and R³ together form an organic compound chain, so that NR²R³ is a ring having n ring atoms, where n is in the range from 5 to 8, (ii) one or more second monomers in a combined mass fraction of 70% or more, where the one or more second monomers are selected from the group consisting of compounds of the formula II) CH₂═CR⁴—C(O)O—R⁵, where R⁴ is hydrogen or a methyl group, where R⁵ is selected from the group consisting of alkyl groups and aryl groups, and (iii) one or more third monomers in a combined mass fraction in the range from 5% to 15%, where the one or more third monomers are selected from the group consisting of compounds of the formula III) CH₂═CR⁶—C(O)O—R⁷, where R⁶ is hydrogen or a methyl group, where R⁷ is selected from the group consisting of hydrogen and hydroxyalkyl groups having 2 to 4 carbon atoms.

What is claimed is:

1. A pressure-sensitive adhesive for bonding printing plates, comprising one or more copolymers in a combined mass fraction of 30% or more, based on a mass of the pressure-sensitive adhesive,
where the one or more copolymers are prepared by polymerizing a monomer composition, where the monomer composition, based on a mass of the monomer composition, comprises:
i) one or more first monomers in a combined mass fraction in the range from 5% to 15%, where the one or more first monomers are selected from the group consisting of compounds of the formula I)
CH₂═CR¹—C(O)NR²R³, I)
where R¹ is hydrogen or a methyl group,
where R² is selected from the group consisting of alkyl groups, hydroxyalkyl groups and acetonyl groups and where R³ is selected from the group consisting of hydrogen, alkyl groups, hydroxyalkyl groups, aryl groups, aminoalkyl groups and acetonyl groups, or where R² and R³ together form an organic compound chain, so that NR²R³ is a ring having n ring atoms, where n is in the range from 5 to 8,
ii) one or more second monomers in a combined mass fraction of 70% or more, where the one or more second monomers are selected from the group consisting of compounds of the formula II)
CH₂═CR⁴—C(O)O—R⁵, II)
where R⁴ is hydrogen or a methyl group,
where R⁵ is selected from the group consisting of alkyl groups and aryl groups, and
iii) one or more third monomers in a combined mass fraction in the range from 5% to 15%, where the one or more third monomers are selected from the group consisting of compounds of the formula III)
CH₂═CR⁶—C(O)O—R⁷, III)
where R⁶ is hydrogen or a methyl group,
where R⁷ is selected from the group consisting of hydrogen and hydroxyalkyl groups having 2 to 4 carbon atoms.

2. The pressure-sensitive adhesive according to claim 1, wherein the pressure-sensitive adhesive comprises the one or more copolymers in a combined mass fraction of 50% or more, based on the mass of the pressure-sensitive adhesive.

3. The pressure-sensitive adhesive according to claim 1, wherein
the one or more copolymers are crosslinked copolymers, and
the crosslinked copolymers are prepared by polymerizing the monomer composition and subsequently crosslinking the polymers obtained by polymerization, the subsequent crosslinking taking place with a chemical crosslinker.

4. The pressure-sensitive adhesive according to claim 3, wherein the chemical crosslinker is selected from the group consisting of polyfunctional epoxides and polyfunctional (meth)acrylates.

5. The pressure-sensitive adhesive according to claim 1, wherein the combined mass fraction of the one or more first monomers in the monomer composition is in the range from 6% to 13%.

6. The pressure-sensitive adhesive according to claim 1, wherein the combined mass fraction of the one or more second monomers in the monomer composition is 75% or more.

7. The pressure-sensitive adhesive according to claim 1, wherein the combined mass fraction of the one or more third monomers in the monomer composition is in the range from 6% to 13%.

8. The pressure-sensitive adhesive according to claim 1, wherein, in the monomer composition, a quotient formed by dividing the combined mass fraction of the one or more first monomers by the combined mass fraction of the one or more third monomers is within a range of from 0.8 to 2.5.

9. The pressure-sensitive adhesive of claim 1, wherein
the one or more first monomers are selected from the group consisting of dimethylacrylamide, N-t-butylacrylamide, and N-acryloylmorpholine.

10. The pressure-sensitive adhesive of claim 1, wherein
the one or more second monomers are selected from the group consisting of butyl (meth)acrylate, ethylhexyl (meth)acrylate, isobornyl acrylate, and isooctyl acrylate.

11. The pressure-sensitive adhesive of claim 1, wherein
the one or more third monomers consists of acrylic acid.

12. The pressure-sensitive adhesive of claim 1, wherein
the one or more first monomers are selected from the group consisting of dimethylacrylamide, N-t-butylacrylamide, and N-acryloylmorpholine,
the one or more second monomers are selected from the group consisting of butyl (meth)acrylate, ethylhexyl (meth)acrylate, isobornyl acrylate, and isooctyl acrylate, and
the one or more third monomers consists of acrylic acid.

13. The pressure-sensitive adhesive of claim 12, wherein
the mass fraction of the acrylic acid in the monomer composition is within a range of from 5% to 15%.

14. The pressure-sensitive adhesive of claim 13, wherein
the one or more copolymers are one or more cross-linked copolymers, and
the one or more cross-linked copolymers are prepared by crosslinking the one or more copolymers with a chemical crosslinker.

15. The pressure-sensitive adhesive of claim 14, wherein
the combined mass fraction of the one or more first monomers in the monomer composition is within a range of from 5% to 15%, and
the combined mass fraction of the one or more second monomers in the monomer composition is within a range of from 70% to 90%.

16. A pressure sensitive adhesive tape comprising:
a carrier layer; and
an adhesive layer on the carrier layer, the adhesive layer comprising a pressure-sensitive adhesive, the pressure-sensitive adhesive comprising:
a pressure-sensitive adhesive for bonding printing plates, comprising one or more copolymers in a combined mass fraction of 30% or more, based on the mass of the pressure-sensitive adhesive,
where the one or more copolymers are prepared by polymerizing a monomer composition, where the monomer composition, based on the mass of the monomer composition, comprises:
i) one or more first monomers in a combined mass fraction in the range from 5% to 15%, where the one or more first monomers are selected from the group consisting of compounds of the formula I)
CH₂═CR¹—C(O)NR²R³, I)
where R¹ is hydrogen or a methyl group,
where R² is selected from the group consisting of alkyl groups, hydroxyalkyl groups and acetonyl groups and where R³ is selected from the group consisting of hydrogen, alkyl groups, hydroxyalkyl groups, aryl groups, aminoalkyl groups and acetonyl groups, or where R² and R³ together form an organic compound chain, so that NR²R³ is a ring having n ring atoms, where n is in the range from 5 to 8,
ii) one or more second monomers in a combined mass fraction of 70% or more, where the second monomers are selected from the group consisting of compounds of the formula II)
CH₂═CR⁴—C(O)O—R⁵, II)
where R⁴ is hydrogen or a methyl group,
where R⁵ is selected from the group consisting of alkyl groups and aryl groups, and
iii) one or more third monomers in a combined mass fraction in the range from 5% to 15%, where the third monomers are selected from the group consisting of compounds of the formula III)
CH₂═CR⁶—C(O)O—R⁷, III)
where R⁶ is hydrogen or a methyl group,
where R⁷ is selected from the group consisting of hydrogen and hydroxyalkyl groups having 2 to 4 carbon atoms.

17. The pressure sensitive adhesive tape of claim 16, wherein
the one or more copolymers are crosslinked copolymers, and
the crosslinked copolymers are prepared by polymerizing the monomer composition and subsequently crosslinking the polymers obtained by polymerization, the subsequent crosslinking taking place with a chemical crosslinker.

18. The pressure sensitive adhesive tape of claim 16, wherein
the combined mass fraction of the one or more first monomers in the monomer composition is in the range from 5% to 15%,
the combined mass fraction of the one or more second monomers in the monomer composition is 75% or more, and
the combined mass fraction of the one or more third monomers in the monomer composition is in the range from 5% to 15%.

19. The pressure sensitive adhesive tape of claim 16, wherein
the one or more first monomers are selected from the group consisting of dimethylacrylamide, N-t-butylacrylamide, and N-acryloylmorpholine,
the one or more second monomers are selected from the group consisting of butyl (meth)acrylate, ethylhexyl (meth)acrylate, isobornyl acrylate, and isooctyl acrylate, and
the one or more third monomers consists of acrylic acid.

20. A method of flexographic printing comprising:
securing a flexible printing plate on a printing cylinder or a printing sleeve with a pressure-sensitive adhesive tape, the pressure-sensitive adhesive tape comprising a pressure-sensitive adhesive,
conducting a printing operation with the flexible printing plate secured onto the printing cylinder or the printing sleeve and with ink that comprises cellulose nitrate or titanium chelate, and
removing the flexible printing plate from the printing cylinder or the printing sleeve,
wherein
the pressure-sensitive adhesive comprises one or more copolymers in a combined mass fraction of 30% or more, based on a mass of the pressure-sensitive adhesive,
the one or more copolymers are prepared by polymerizing a monomer composition,
the monomer composition, based on a mass of the monomer composition, comprises:
i) one or more first monomers in a combined mass fraction in the range from 5% to 15%, where the one or more first monomers are selected from the group consisting of compounds of the formula I)
CH₂═CR¹—C(O)NR²R³, I)
where R¹ is hydrogen or a methyl group,
where R² is selected from the group consisting of alkyl groups, hydroxyalkyl groups and acetonyl groups and where R³ is selected from the group consisting of hydrogen, alkyl groups, hydroxyalkyl groups, aryl groups, aminoalkyl groups and acetonyl groups, or where R² and R³ together form an organic compound chain, so that NR²R³ is a ring having n ring atoms, where n is in the range from 5 to 8,
ii) one or more second monomers in a combined mass fraction of 70% or more, where the one or more second monomers are selected from the group consisting of compounds of the formula II)
CH₂═CR⁴—C(O)O—R⁵, II)
where R⁴ is hydrogen or a methyl group,
where R⁵ is selected from the group consisting of alkyl groups and aryl groups, and
iii) one or more third monomers in a combined mass fraction in the range from 5% to 15%, where the one or more third monomers are selected from the group consisting of compounds of the formula III)
CH₂═CR⁶—C(O)O—R⁷, III)
where R⁶ is hydrogen or a methyl group,
where R⁷ is selected from the group consisting of hydrogen and hydroxyalkyl groups having 2 to 4 carbon atoms.
